(19) United States
(12) Patent Application Publication
(10) Pub. No.: US 2026/0116793 A1
(43) Pub. Date: Apr. 30, 2026

(54) DEIONIZED WATER PRODUCTION DEVICE AND METHOD

(71) Applicant: KURITA WATER INDUSTRIES LTD., Tokyo (JP)

(72) Inventor: Teruhisa KATO, Tokyo (JP)

(73) Assignee: KURITA WATER INDUSTRIES LTD., Tokyo (JP)

(21) Appl. No.: 18/853,137

(22) PCT Filed: Mar. 31, 2023
(86) PCT No.: PCT/JP2023/013548

§ 371 Date: Oct. 1, 2024

(30) Foreign Application Priority Data
Apr. 11, 2022 (JP) 2022-065197

(51) Int. Cl. C02F 1/469; C02F 1/20; C02F 1/42; C02F 1/44

(52) U.S. Cl. CPC C02F 1/4695; C02F 1/20; C02F 1/42; C02F 1/441; C02F 2201/46115

(57) ABSTRACT

In an electrodeionization device, a concentration compartment and a desalting compartment are defined by ion exchange membranes between a positive electrode and a negative electrode; concentrated water is caused to flow into the concentration compartment; water to be treated is caused to flow into the desalting compartment and is extracted as deionized water; and part of the deionized water is caused to flow as concentrated water into the concentration compartment in a direction opposite the flow direction of the desalting compartment. Water supplied to the electrodeionization device is treated using a water softener, an RO device, and a membrane degassing device, and the total concentration of Ca ions and Mg ions is 50 μg/L or lower.

### TECHNICAL FIELD

The present invention relates to a deionized water production device using an electrodeionization device and a deionized water production method.

### RELATED ART

In general, an electrodeionization device is configured such that cation exchange membranes and anion exchange membranes are alternately arranged between a negative electrode and a positive electrode to form desalting compartments and concentration compartments, and the desalting compartments are filled with ion exchange resin. As ion exchange membranes such as cation exchange membranes and anion exchange membranes, heterogeneous membranes formed by adding a binder such as polystyrene to a powdered ion exchange resin, homogeneous membranes formed by polymerization of styrene-divinylbenzene, and membranes formed by graft polymerization of various monomers having anion exchange function or cation exchange function are used.

In an electrodeionization device, when raw water is passed through the desalting compartment and concentrated water is passed through the concentration compartment and an electric current is applied between the negative electrode and the positive electrode, ions move from the desalting compartment through the anion exchange membrane and cation exchange membrane to the concentration compartment, and deionized water (pure water) is obtained from the desalting compartment. The ion-enriched concentrated water flowing through the concentration compartment is either discarded or partially recycled. Such electrodeionization devices are used in various industries, for example as ultrapure water producing devices for use in semiconductor manufacturing and the like.

In order to improve the quality of treated water from an electrodeionization device, a treated water counterflow type electrodeionization device has been proposed in which part of the treated water is branched off and passed as concentrated water in a direction opposite the supply water (Patent Documents 1 and 2). With this electrodeionization device, the concentration of the concentrated water adjacent to the deionized water outlet is made the same as that of the deionized water, preventing ion diffusion due to the difference in concentration from the concentrated water to the deionized water, thereby improving the quality of the treated water.

Patent Document 3 describes the installation of a reverse osmosis membrane device (RO device) as a pretreatment part upstream of an electrodeionization device in order to improve the quality of treated water from the electrodeionization device. FIGS. 1 and 2 of Patent Document 3 show that RO devices are installed in series in two stages as a pretreatment part.

### PRIOR-ART DOCUMENT

### Patent Document

Patent Document 1: Japanese Patent Laid-open No. 2002-205069

Patent Document 2: Japanese Patent Laid-open No. 2017-176968

Patent Document 3: Japanese Patent Laid-open No. 2003-1259

### SUMMARY OF INVENTION

### Problems to be solved by the Invention

Hardness components such as Ca in the supply water of an electrodeionization device cause scale such as CaCO3 to form in the electrodeionization device. When scale is formed, the electrical resistance of the electrodeionization device increases, causing problems such as an increase in the power consumption of the electrodeionization device and a shortened life of the DC power supply.

An object of the present invention is to provide a deionized water production device capable of suppressing scale formation in an electrodeionization device, and a deionized water production method using the deionized water production device.

### Means for solving the Problems

The deionized water production device according to the present invention includes an electrodeionization device in which a concentration compartment and a desalting compartment are defined by an ion exchange membrane between a positive electrode and a negative electrode, concentrated water is caused to flow into the concentration compartment, water to be treated is caused to flow into the desalting compartment and extracted as deionized water, and the desalting compartment, the concentration compartment, and an electrode compartment are filled with ion exchange resin; and a pretreatment part for pretreating supply water to the electrodeionization device. The pretreatment part makes a total concentration of Ca ions and Mg ions in the supply water 50 μg/L or lower.

In one aspect of the present invention, the pretreatment part includes a water softener, a reverse osmosis membrane device, and a membrane degassing device.

In one aspect of the present invention, the pretreatment part makes a total concentration of carbonate ions and silicate ions in the supply water 1,000 μg/L or lower.

In one aspect of the present invention, the pretreatment part makes a specific resistance of the supply water 2 MΩ·cm or more.

In one aspect of the present invention, in the electrodeionization device, part of the deionized water from the desalting compartment is passed through the concentration compartment in a direction opposite a flow direction of the desalting compartment.

The deionized water production method of the present invention is characterized in that deionized water is produced using the deionized water production device.

### Effects of Invention

As a result of extensive research conducted by the present inventor, it has been found that in an electrodeionization device in which a concentration compartment and a desalting compartment are defined by an ion exchange membrane between a positive electrode and a negative electrode, concentrated water is caused to flow into the concentration compartment, and raw water is caused to flow into the desalting compartment and the concentration compartment as water to be treated, and extracted as deionized water, hardness components (Ca, Mg, etc.), which cause scaling, combine with anions (carbonate ions, silicate ions, etc.) and accumulate as scale, even if their concentrations are not high. As scale accumulation progresses, the electrical resistance of the electrodeionization device increases, causing an increase in voltage and a decrease in ion removal performance.

According to the present invention, by removing hardness components from the supply water, it is possible to suppress a voltage rise in the electrodeionization device and stably produce deionized water of good quality over a long period of time.

Furthermore, even if hardness components are removed from the supply water, the quality of the treated water will decline if other ions are present in high concentrations in the supply water. However, good treated water quality can be maintained by a concentrated water passing method by branching off part of the treated water and passing it through the concentration compartment using a counterflow manner.

### BRIEF DESCRIPTION OF DRAWINGS

FIG. 1 is a schematic cross-sectional diagram of an electrodeionization device used in an embodiment.

FIG. 2 is a flow diagram of a deionized water production device according to an embodiment.

FIG. 3 is a flow diagram of a Comparative Example.

FIG. 4 is a graph showing the results of the Examples and Comparative Example s.

### DESCRIPTION OF THE EMBODIMENTS

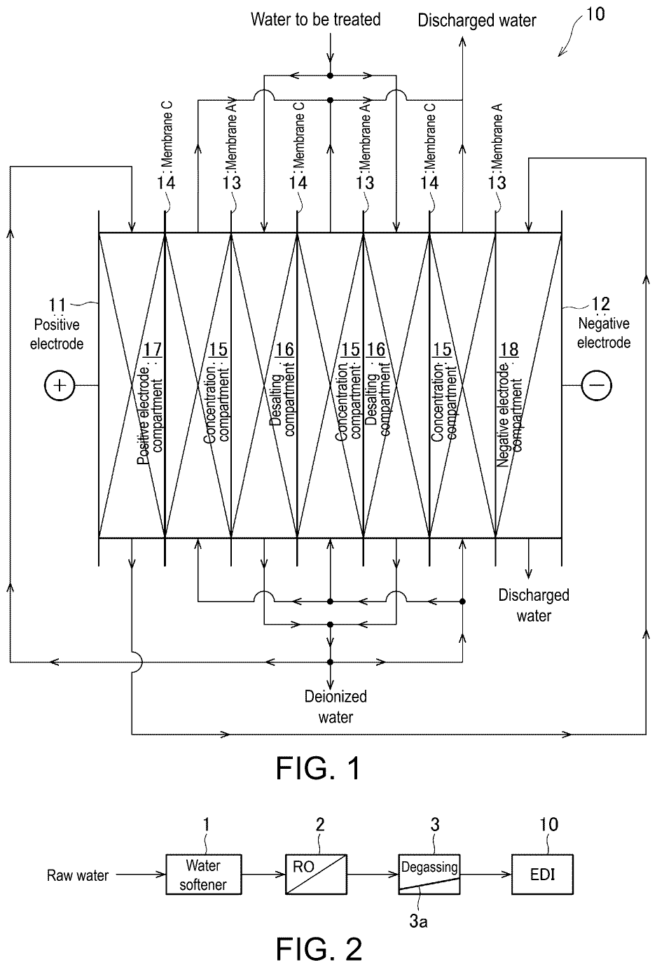

FIG. 1 is a schematic cross-sectional diagram of an electrodeionization device 10 according to an embodiment of the present invention. The electrodeionization device 10 has a plurality of anion exchange membranes (membrane A) 13 and cation exchange membranes (membrane C) 14 arranged alternately between electrodes (positive electrode 11, negative electrode 12) to form alternating concentration compartments 15 and desalting compartments 16, and the desalting compartments 16 are filled with ion exchange resin.

Moreover, the concentration compartment 15, a positive electrode compartment 17 and a negative electrode compartment 18 are also filled with ion exchange resin.

Supply water is introduced into the inlet side of the desalting compartment 16, and deionized water is extracted from the outlet side of the desalting compartment 16. Part of the deionized water is passed through the concentration compartment 15 in a countercurrent manner in the direction opposite to the water flow direction through the desalting compartment 16, and the outflow water from the concentration compartment 15 is discharged outside the system. That is, in this electrodeionization device 10, the concentration compartments 15 and the desalting compartments 16 are arranged alternately side by side, and the inlet of the concentration compartment 15 is provided on the deionized water extraction side of the desalting compartment 16, and the outlet of the concentration compartment 15 is provided on the water to be treated inflow side of the desalting compartment 16. Furthermore, part of the deionized water is fed to the inlet side of the positive electrode compartment 17, the outflow water from the positive electrode compartment 17 is fed to the inlet side of the negative electrode compartment 18, and the outflow water from the negative electrode compartment 18 is discharged outside the system as wastewater.

When the water to be treated is passed in the up-down direction through the desalting compartment 16, it is preferable that the ion exchange resin filling height of the desalting compartment 16 is 400 to 800 mm, and the widths of the desalting compartment 16, the concentration compartment 15, the positive electrode compartment 17 and the negative electrode compartment 18 (dimensions perpendicular to the paper surface in FIG. 1) are 10 to 60 mm.

The mixing ratio of the mixed resins of anion exchange resin and cation exchange resin filled in the desalting compartment 16 is preferably in the range of anion exchange resin: cation exchange resin=60-90:40-10, particularly 60-80:40-20 (dry weight ratio).

The ion exchange resin filled in the concentration compartment 15, the positive electrode compartment 17 and the negative electrode compartment 18 is also preferably a mixed resin of anion exchange resin and cation exchange resin. In particular, it is preferable to be a mixed resin with anion exchange: cation exchange resin=40-70:60-30, preferably 50-70:50-30 (dry weight ratio).

The particle size of the ion exchange resin is preferably in the range of 0.1 to 0.7 mm. Moreover, in the present invention, the average diameter (average particle size) and resin ratio of the ion exchange resin are values in a wet state of the regenerated type (OH type, H type), and the average diameter is a weight average.

The small particle size ion exchange resin not only improves the performance of removing difficult-to-remove ions such as boron and silica, but also has the effect of lowering the operating voltage. When an ion exchange resin having a small average particle size is used, the surface area of the ions increases, which reduces the electrical resistance and allows for a margin in the upper voltage limit that determines the operating life, enabling operation over a longer life span.

In the present invention, the thickness of the desalting compartment 16 (the distance between membrane A and membrane C) may be increased to 2.5 to 20 mm for the purpose of reducing costs. By making the desalting compartment thicker, the number of ion exchange membranes and concentration compartments may be reduced. Furthermore, by reducing the ion exchange membrane, electrical resistance can be reduced, enabling longer operating life. The number of desalting compartments is preferably about 1 to 300, and more preferably about 10 to 200.

In the present invention, it is preferable to pass the water to be treated through the desalting compartment 16 of the electrodeionization device 10 and pass part of the deionized water (outflow water from the desalting compartment), for example, about 10 to 30%, through the concentration compartment in the direction opposite to the water flow direction through the desalting compartment, in terms of obtaining a high removal rate of boron, silica, etc. Furthermore, as the water flow rate at this time, in terms of the removal rate of boron, silica, etc. and the treatment efficiency, the water flow linear velocity in the desalting compartment is preferably 60 to 100 m/h, particularly 70 to 90 m/h, and the water flow linear velocity in the concentration compartment is preferably 5 to 20 m/h, particularly 10 to 15 m/h.

The current density is preferably 10 A/m² or more, particularly 10 to 150 A/m², and more particularly 10 to 120 A/m², in order to achieve a high boron and silica removal rate.

FIG. 2 is a flow diagram of a deionized water production device using the electrodeionization device.

In the embodiment, a water softener 1, an RO device 2, and a membrane degassing device 3 are provided as pretreatment part for pretreatment of raw water. The water softener 1 is a device in which a water-passing container is filled with a mixture of anion exchange resin and cation exchange resin, but may be an ion exchanger of a two-bed three-tower type, a three-bed four-tower type, or the like.

Examples of raw water supplied to the water softener 1 include city water, industrial water, and the like, but are not limited thereto. The total concentration of Ca ions and Mg ions in the outflow water from the water softener 1 is preferably 1.0 mg/L or lower, for example, 0.01 to 1.0 mg/L, and particularly preferably about 0.01 to 0.8 mg/L.

It is preferable that the outflow water from the water softener 1 is passed through the RO device 2 to produce RO treated water having a total concentration of Ca ions and Mg ions of 50 μg/L or lower.

The membrane degassing device 3, through which the RO treated water is passed, has a water passage compartment and a pressure reduction compartment separated by a degassing membrane 3a, and is configured such that the RO treated water is passed through the water passage compartment and the pressure inside the pressure reduction compartment is reduced by a vacuum pump. The CO₂ in the RO treated water permeates the degassing membrane and is removed from the water.

The total concentration of carbonate ions and silicate ions in the treated water from the membrane degassing device 3 is preferably 1000 μg/L or lower, and particularly preferably 650 μg/L or lower. The total concentration of Ca ions and Mg ions in the treated water from the membrane degassing device 3 is preferably 50 μg/L or lower. The specific resistance of the treated water from the membrane degassing device 3 is preferably 2 MΩ·cm or more.

In this manner, the pretreated water that has been pretreated in the water softener 1, the RO device 2, and the membrane degassing device 3 is supplied to the electrodeionization device 10, where it is treated as described above to produce deionized water.

### EXAMPLE

The present invention will be described more specifically below with reference to Examples.

### Example 1

As shown in FIG. 2, water obtained by treating raw water by a water softener 1, a RO device 2, and a membrane degassing device 3 was passed through an electrodeionization device 10.

The raw water used was tap water from Nogi Town, Tochigi Prefecture, Japan. The raw water had a total hardness (total concentration of Ca ions and Mg ions) of 70 mg/L, a carbonate ion concentration of 40 mg/L, and a silicate ion concentration of 20 mg/L.

The water softener 1 was filled with a mixture of anion exchange resin and cation exchange resin, and water was passed through at SV=20 hr⁻¹. The total hardness (total concentration of Ca ions and Mg ions) of the outflow water from the water softener 1 was 10 μg/L, the carbonate ion concentration was 40 mg/L, and the silicate ion concentration was 20 mg/L.

The pretreated water that has been pretreated from the water softener 1 through the RO device 2 and the membrane degassing device 3 has a Ca ion concentration of 4 μg/L, an Mg ion concentration of 4 μg/L, a carbonate ion concentration of 500 μg/L, and a silicate ion concentration of 150 μg/L. Moreover, the electrical conductivity of the pretreated water was 0.5 mS/m (specific resistance 2 MΩ·cm).

The electrodeionization device 10 is an electrodeionization device in which a plurality of anion exchange membranes and cation exchange membranes are alternately arranged between a positive electrode and a negative electrode to form concentration compartments and desalting compartments alternately. The thickness of the desalting compartment and the concentration compartment is 10 mm, and the number of desalting compartments is 15. The electrodeionization device 10 is installed such that the water flows vertically through the desalting compartments and the concentration compartments. The desalting compartment and the concentration compartment are filled with ion exchange resin. The ion exchange resin filling height of the desalting compartment and the concentration compartment is 600 mm, and the width of the desalting compartment and the concentration compartment is 10 mm.

The desalting compartment, concentration compartment, positive electrode compartment and negative electrode compartment were filled with a mixed resin of anion exchange resin and cation exchange resin (anion exchange resin: cation exchange resin ratio 50:50). The anion exchange resin has an average particle size of 0.6 mm, and the cation exchange resin has an average particle size of 0.6 mm.

A current with a current density of 10 A/m² was applied to the electrodeionization device 10, and the pretreated water was flowed downward into the desalting compartment at LV=80 m/hr, 10% of the outflow water from the desalting compartment was flowed upward into the concentration compartment at LV=30 m/hr, and about 0.5% of the outflow water from the desalting compartment was flowed downward into the positive electrode compartment at LV=30 m/hr and then downward into the negative electrode compartment at LV=30 m/hr. The remainder of the outflow water from the desalting compartment was extracted as treated water (deionized water) (amount of deionized water: 15 m3/h, recovery rate: about 90%).

The change over time in the applied voltage of this electrodeionization device 10 is shown in FIG. 4.

### Comparative Example 1

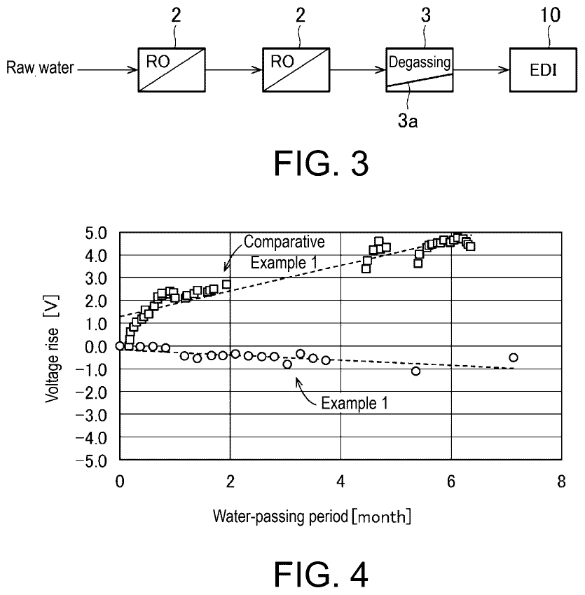

In Example 1, a RO device 2 was installed instead of the water softener 1, and the pretreatment device was configured as a two-stage RO+ membrane degassing device as shown in FIG. 3, and the water to be treated was passed through under the same conditions as in Example 1. The change over time in the applied voltage of this electrodeionization device 10 is shown in FIG. 4.

In the Comparative Example 1, the pretreated water pretreated through the two-stage RO device 2, 2 and the membrane degassing device 3 had a Ca ion concentration of 200 μg/L, a Mg ion concentration of 200 μg/L, a carbonate ion concentration of 500 μg/L, and a silicate ion concentration of 150 μg/L. Moreover, the electrical conductivity of the pretreated water was 0.5 mS/m (specific resistance 2 MΩ·cm).

### Results and Discussion

As shown in FIG. 4, in Example 1, the applied voltage did not increase over a period of 7 months, whereas in Comparative Example 1, the applied voltage increased by about 5 V over a period of 6 months.

Although the present invention has been described in detail with reference to specific aspects, it will be apparent to those skilled in the art that various modifications may be made without departing from the spirit and scope of the invention.

This application is based on Japanese Patent Application No. 2022-065197 filed on Apr. 11, 2022, the entirety of which is incorporated by reference.

### REFERENCE SIGNS LIST

1 Water softener
2 RO device
3 Membrane degassing device
10 Electrodeionization device
11 Positive electrode
12 Negative electrode
13 Anion exchange membrane
14 Cation exchange membrane
15 Concentration compartment
16 Desalting compartment

1. A deionized water production device, comprising:
an electrodeionization device in which a concentration compartment and a desalting compartment are defined by an ion exchange membrane between a positive electrode and a negative electrode, concentrated water is caused to flow into the concentration compartment, water to be treated is caused to flow into the desalting compartment and extracted as deionized water, and the desalting compartment, the concentration compartment, and an electrode compartment are filled with ion exchange resin;
a pretreatment part for pretreating supply water to the electrodeionization device,
wherein the pretreatment part makes a total concentration of Ca ions and Mg ions in the supply water 50 μg/L or lower.

2. The deionized water production device according to claim 1, wherein the pretreatment part comprises a water softener, a reverse osmosis membrane device, and a membrane degassing device.

3. The deionized water production device according to claim 1, wherein the pretreatment part makes a total concentration of carbonate ions and silicate ions in the supply water to the electrodeionization device 1,000 μg/L or lower.

4. The deionized water production device according to claim 1, wherein the pretreatment part makes a specific resistance of the supply water to the electrodeionization device 2 MΩ·cm or more.

5. The deionized water production device according to claim 1, wherein in the electrodeionization device, part of the deionized water from the desalting compartment is passed through into the concentration compartment in a direction opposite a water flow direction of the desalting compartment.

6. A deionized water production method using the deionized water production device according to claim 1.

7. The deionized water production device according to claim 2, wherein the pretreatment part makes a total concentration of carbonate ions and silicate ions in the supply water to the electrodeionization device 1,000 μg/L or lower.

8. The deionized water production device according to claim 2, wherein the pretreatment part makes a specific resistance of the supply water to the electrodeionization device 2 MΩ·cm or more.

9. The deionized water production device according to claim 3, wherein the pretreatment part makes a specific resistance of the supply water to the electrodeionization device 2 MΩ·cm or more.

10. The deionized water production device according to claim 2, wherein in the electrodeionization device, part of the deionized water from the desalting compartment is passed through into the concentration compartment in a direction opposite a water flow direction of the desalting compartment.

11. The deionized water production device according to claim 3, wherein in the electrodeionization device, part of the deionized water from the desalting compartment is passed through into the concentration compartment in a direction opposite a water flow direction of the desalting compartment.

12. The deionized water production device according to claim 4, wherein in the electrodeionization device, part of the deionized water from the desalting compartment is passed through into the concentration compartment in a direction opposite a water flow direction of the desalting compartment.

13. A deionized water production method using the deionized water production device according to claim 2.

14. A deionized water production method using the deionized water production device according to claim 3.

15. A deionized water production method using the deionized water production device according to claim 4.

16. A deionized water production method using the deionized water production device according to claim 5.
